(19) United States
(12) Patent Application Publication
(10) Pub. No.: US 2023/0305153 A1
(43) Pub. Date: Sep. 28, 2023

(54) LIDAR DEVICE

(71) Applicant: Robert Bosch GmbH, Stuttgart (DE)

(72) Inventor: Johannes Richter, Renningen (DE)

(21) Appl. No.: 18/041,510

(22) PCT Filed: Sep. 28, 2021
(86) PCT No.: PCT/EP2021/076610

§ 371 Date: Feb. 13, 2023

(30) Foreign Application Priority Data
Oct. 23, 2020 (DE) 10 2020 213 383.2

(51) Int. Cl. G01S 17/58; G01S 7/481; G01S 7/4865

(52) U.S. Cl. CPC G01S 17/58; G01S 7/4814; G01S 7/4816; G01S 7/4865

(57) ABSTRACT

A lidar device. The lidar device includes: a transmitter device having at least one laser element; a detector device having a defined number of detector pixels; the transmitter being capable of emitting pulsed transmit signals, which signals, reflected by an object, are received by the detector device as receive signals; and an evaluation device by which a speed of a detected object can be ascertained from arrival times of the receive signals acquired per detector pixel in relation to transmission times of the transmit signals.

### FIELD

The present invention relates to a lidar device. The present invention further relates to a method for operating a lidar device. The present invention further relates to a computer program product.

### BACKGROUND INFORMATION

Highly automated vehicles (SAE levels 3-5) will be increasingly used on public roads in the coming years. All conventional designs of automated vehicles require a combination of different conventional environment detection sensors, such as camera, radar, lidar, etc. The latter environment detection sensors are basically laser scanners that emit laser light pulses and measure and evaluate times of the arrival of laser light reflected from an object. The lidar sensors can determine a distance to the object from the measured time of flight.

Some conventional radar sensors are able to measure speeds of objects via the Doppler shift of frequencies.

Some lidar sensors use a similar principle (frequency-modulated continuous wave technology, FMCW) to measure the Doppler shift of light, although these sensors are currently still in the research stage.

European Patent No. EP 2 819 901 B1 describes a method for ascertaining the speed of a vehicle equipped with at least one environment sensor that ascertains environmental data of the vehicle relative to at least one non-moving object.

### SUMMARY

It is an object of the present invention to provide an improved lidar device.

According to a first aspect, the present invention provides a lidar device. According to an example embodiment of the present invention, the lidar device includes:
a transmitter device with at least one laser element;
a detector device with a defined number of detector pixels; where
pulsed transmission signals can be emitted by the transmitter device, which, reflected by an object, are received by the detector device as receive signals; and
an evaluation device by which a speed of a detected object can be ascertained from arrival times of the receive signals acquired per detector pixel in relation to transmission times of the transmitted signals.

Advantageously, in this way a lidar device is provided with which the radial speed of objects can also be measured.

Advantageously, in this way the use of a radar system for an automated vehicle can be saved, in some circumstances.

According to a second aspect of the present invention, the problem is solved with a method for operating a lidar device.

According to an example embodiment of the present invention, the method includes the following steps:
Repetitive emitting of transmit signals of a transmitting device with at least one laser element;
Reception of receive signals reflected by an object; and
Evaluation of the arrival times of the receive signals acquired per detector pixel in relation to transmission times of the transmitted signals, a speed of a detected object being ascertained.

Preferred specific embodiments of the lidar device are disclosed herein.

According to advantageous developments of the lidar device of the present invention, a number of the laser elements and a number of the detector pixels is the same or different.

Advantageously, different measurement and evaluation designs for ascertaining the radial speed of the objects are supported in this way.

In a further advantageous development of the lidar device according to the present invention, the evaluation is carried out directly on a detector pixel or on a central computing unit. Advantageously, this provides various possibilities for evaluating the acquired data; here, for reasons of efficiency, an evaluation of the data as close to hardware as possible, using a detector ASIC or detector FPGA, can be expedient.

Another advantageous development of the lidar device of the present invention provides that the measurements are carried out individually for each detector pixel.

Another advantageous further development of the lidar device of the present invention provides that the measurements for a plurality of detector pixels are carried out simultaneously.

Advantageously, in these ways different measurement and evaluation designs for determining the radial speed are made possible.

Another advantageous development of the lidar device of the present invention provides that a minimum error square is used for the adjustment between measurement values. Used by a simple mathematical method for the efficient evaluation of the measurement data for the purpose of extracting the radial speed.

According to a further advantageous development of the lidar device of the present invention, a further object can be detected from a goodness of fit of a mathematical function between the measurement values. This provides an option by which an erroneous measurement can be recognized, enabling, e.g., a central control unit to interpret the acquired data correctly.

In further advantageous specific embodiments of the lidar device of the present invention, the detector pixel is one of the following: SPAD diode, avalanche photodiode, CCD sensor.

Advantageously, the detector pixel in the form of the SPAD diode can thus be used to carry out repetitive measurements anyway, whereby the proposed evaluation of the data and extraction of the speed provides an additional benefit without additional measurement time. Alternatively, other types of detector pixels can be used, allowing a variety of different detector pixels to be used.

The present invention is described in detail below with further features and advantages, on the basis of several figures.

Identical or functionally identical components have the same reference signs. The figures are intended in particular to illustrate the main features of the present invention, and are not necessarily to scale.

Disclosed device features result analogously from corresponding disclosed method features, and vice versa. This means in particular that features, technical advantages, and embodiments relating to the lidar device result in an analogous manner from corresponding embodiments, features, and advantages of the method for operating a lidar device and vice versa.

### BRIEF DESCRIPTION OF THE DRAWINGS

FIG. 1 shows a highly simplified representation of a lidar device, according to an example embodiment of the present invention

FIG. 2 shows a schematic layout of a transmitting unit and a receiving unit of a lidar device, according to an example embodiment of the present invention.

FIG. 3 shows a time diagram of an analysis of proposed repetitive lidar measurements, according to an example embodiment of the present invention.

FIG. 4 shows an exemplary repetitive measurement sequence of a lidar sensor with a 10 Hz frame and five pixels, according to an example embodiment of the present invention.

FIG. 5 shows another exemplary repetitive measurement sequence of a lidar sensor for another object located in the measurement path, according to an example embodiment of the present invention.

FIG. 6 shows a schematic block diagram of a lidar device according to an example embodiment of the present invention.

FIG. 7 shows a flow diagram of an example method for operating an example lidar device, according to the present invention.

### DETAILED DESCRIPTION OF EXAMPLE EMBODIMENTS

A main feature of the present invention is in particular to provide a lidar sensor capable of carrying out both distance and radial speed measurements of detected objects.

In this context, for the lidar device according to an example embodiment of the present invention, a detector device having a plurality of detector pixels is provided, a defined high number of repeating measurements being carried out for each detector pixel, and radial speeds of the detected objects being extracted from these data.

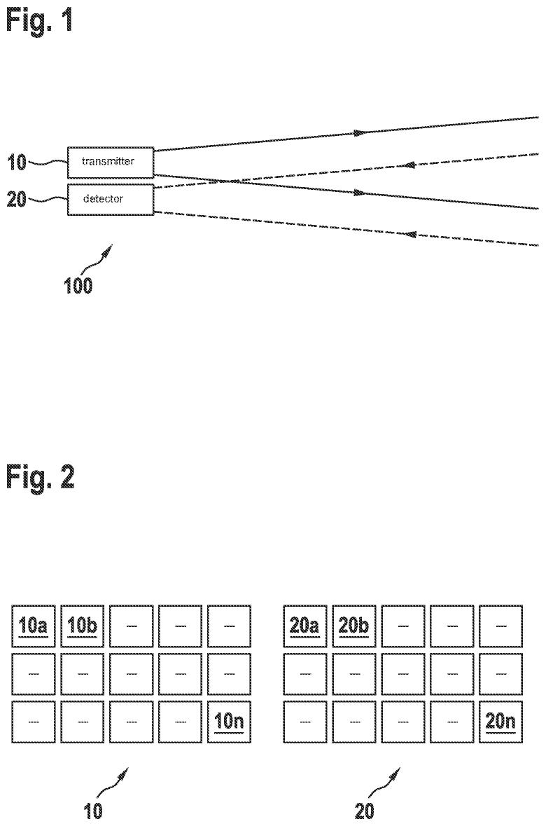

FIG. 1 shows a highly simplified block diagram of a proposed “pulsed” lidar device 100. Lidar device 100 includes a transmitter device 10 having one or more laser elements 10a . . . 10n that emit pulsed electromagnetic radiation or electromagnetic radiation pulses that are reflected by an object, the reflections of the pulsed electromagnetic radiation, or electromagnetic radiation pulses, being received by a detector device 20 with the detector pixels. Directions of emitted and received radiation pulses are indicated by arrows.

FIG. 2 shows lidar device 100 of FIG. 1 with a higher degree of detail. It will be seen that lidar device 100 includes a plurality of laser elements 10a . . . 10n and a plurality of detector pixels 20a . . . 20n, each detector pixel 20a . . . 20n being associated with a respective laser element 10a . . . 10n, whereby a number of the laser elements 10a . . . 10n corresponds to a number of the detector pixels 20a . . . 20n. Laser elements 10a . . . 10n (e.g. in the form of VCSEL, DBR lasers, etc.) are configured in columns and rows in the form of a matrix. A lens (not shown) situated in front of the laser matrix directs the radiation pulses of the individual laser elements 10a . . . 10n in different directions.

A second lens (not shown) situated in front of the detector matrix maps the reflected radiation pulses onto detector pixels 20a . . . 20n, which are also configured in the form of a matrix, similar to laser elements 10a . . . 10n of the laser matrix. The lens is formed in such a way that each detector pixel 20a . . . 20n the reflected radiation pulses that were emitted by an associated laser element 10a . . . 10n are measured and evaluated according to the present invention.

In an alternative specific embodiment of the proposed lidar device 100, the number of laser elements 10a . . . 10n is different from the number of detector pixels 20a . . . 20n, so that, for example, n laser elements 10a . . . 10n are mapped onto m detector pixels 20a . . . 20n. For example, a single laser element 10a . . . 10n may be used in each column, its radiation pulses being mapped onto the corresponding column of the detector pixel 20a . . . 20n. In another embodiment, a single laser element 10a . . . 10n can be used to completely and instantaneously illuminate the entire field of view of lidar device 100 (flash lidar).

Each individual detector pixel 20a . . . 20n of the detector matrix can be formed, for example, as a single photon avalanche diode (SPAD), i.e., as a photodetector with a singular detection sensitivity. It is also possible to realize detector pixels 20a . . . 20n as avalanche photodiodes (APD) or as CCD elements.

An electronic evaluation circuit 30 reads out each individual detector pixel 20a . . . 20n (e.g., SPAD element), and the associated time of arrival of the photon is recorded. 0 ns corresponds here to the time at which the radiation pulse associated with the received photon was emitted. Due to the binary detection characteristic of the SPAD pixels, multiple repetitive measurements for each detector pixel 20a . . . 20n are necessary to make it possible to distinguish useful signals from noise signals such as background light. After that, a statistic or histogram of all registered events is created as a function of the arrival time. A number of repetitions for each detector pixel 20a . . . 20n is preferably on the order of about 100 repetitions, making it possible, using the histogram, to distinguish true detection events from background photons.

An extraction of data relating to a radial speed of an object in the following way is provided according to the present invention:

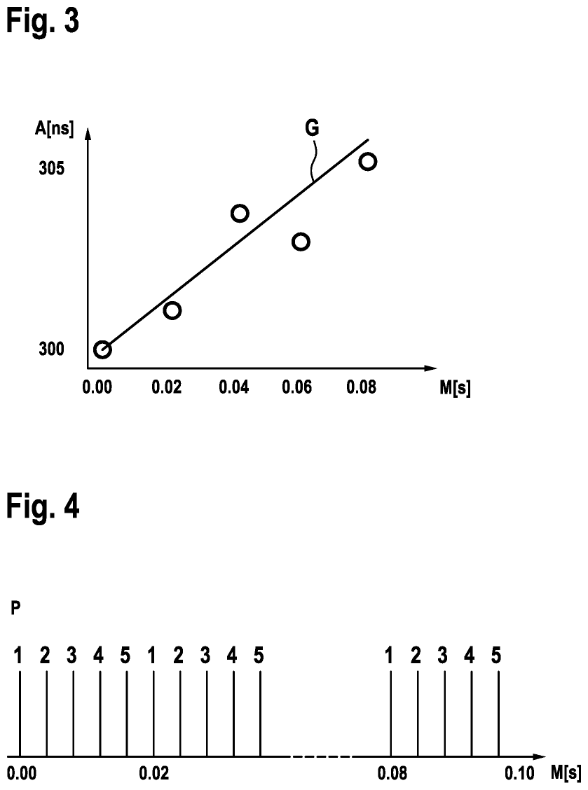

If the histogram indicates that the lidar device 100 detects an object, the histogram can be used to determine the individual arrival time, i.e., the temporal arrival of the photon after the emission of an associated laser pulse) as a function of the measurement time M (e.g. UTC time), for example by plotting the arrival time A as a function of the absolute measurement time M, as indicated for example in FIG. 3 on the basis of five events or repetitions or arrival times of reflection signals. As the object moves away from the lidar device 100, the arrival times over the repeating measurements will become longer, as indicated in FIG. 3 on the basis of the five measurements. A slope of a straight line G formed from the measurement data can be determined, for example, by linear approximation using the least error square, which allows a radial speed of the detected object to be extracted in a simple manner.

From the ascertained straight line slope, the radial speed of the object can be ascertained as follows:

v=S×c/2 (1)
with:
v . . . radial speed of the object
S . . . slope of the straight line
c . . . speed of light

Here, the factor 2 results from the fact that the light has to travel a path between lidar device 100 and the object twice. For example, in FIG. 3, the slope of the straight line is about 7×10⁻⁸, which corresponds to a radial speed of about 10 m/s (36 km/h) of the detected object.

The proposed lidar sensor preferably operates at a frame rate of the order of approximately 10 Hz, the frame rate corresponding to a sum of all detector pixels 20a . . . 20n of detector device 20. This means a time duration of approximately 100 ms is required for all measurements of a complete frame with all detector pixels 20a . . . 20n. With a typical time resolution of the SPAD pixels of about lns, this allows speeds to be measured with a resolution of about 1 m/s, which is approximately the speed of a pedestrian. At a frame rate of 25 Hz, the speed resolution is about 2.5 m/s, which is approximately the speed of a slow cyclist.

As a result, when an object is detected, an analysis of the detected events is carried out in this way, the arrival times of the repetitions per detector pixel 20a . . . 20n being analyzed as a function of the measurement time M.

The named measurements and evaluations of the individual detector pixels 20a . . . 20n can be carried out in parallel, so that a number of radiation pulses and the corresponding measurements can be carried out simultaneously.

Alternatively, the detector pixels 20a . . . 20n can also be measured and evaluated one after the other. In order to measure speeds, it can be convenient to distribute the repetitions of the individual detector pixels 20a . . . 20n as broadly as possible in time. Instead of carrying out 100 repetitions for a single detector pixel 20a . . . 20n directly one after the other, it may be convenient to carry out measurements and evaluations of a single detector pixel 20a . . . 20n with all provided repetition measurements completely at first, before carrying out the measurement and evaluation of the next detector pixel 20a . . . 20n.

FIG. 4 shows an exemplary laser transmission sequence and measurement pattern for a simplified case (pixel number P=5) of detector pixels 20a . . . 20e that are measured and evaluated with several repetitions. In practice, however, the number P of detector pixels 20a . . . 20n as well as the number of repetitions of pixel measurements can be considerably higher (e.g. several hundred repetitions per frame). It can be seen that the lidar device 100 first measures all five detector pixels 20a . . . 20e (P=1 through 5) before starting a second repetition of the five detector pixels 20a . . . 20e. In this way, the speed information for each detector pixel can be extracted very accurately.

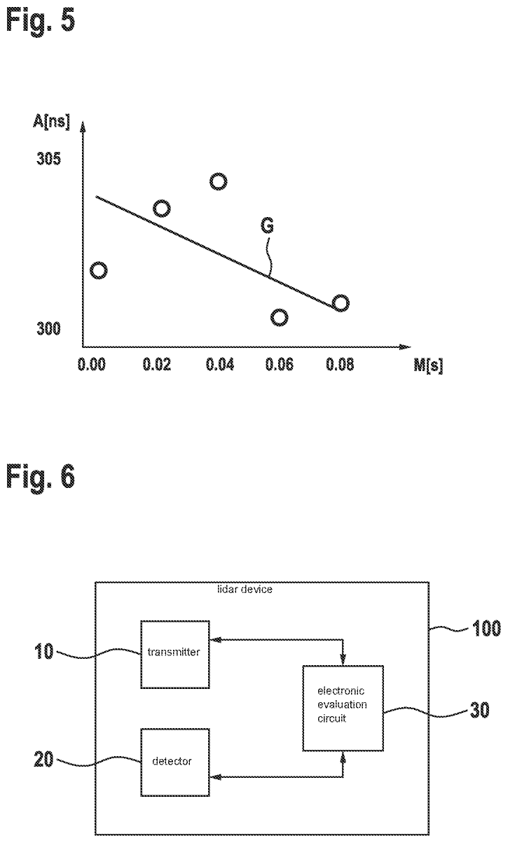

The provided method is advantageously able to distinguish between true velocity measurements and measurements of artifacts that are detected, for example, when another object moves into the signal path in the center of a measurement frame. In this case, the arrival time shows a discontinuity with respect to the measurement time, as is shown as an example in FIG. 5. A linear approximation of the data shows a larger minimum error square, which is an indication of an unsuccessful linear approximation of the data and thus an unsuccessful speed measurement. It can be seen that a linear trend of the first three detections is abruptly disturbed by the fourth and fifth detections, so that a straight line between the first three detections is strongly changed when all five detections are taken into account. In practice, this may occur for example when an object moves transversely to the detection direction of lidar device 100, abruptly changing a detection characteristic of lidar device 100.

If the minimum error square value is greater than a predefined threshold value, the system cannot assign a speed to a detected object and in this case can, for example, transmit a signal to a central computing unit, signaling that a detector pixel 20a . . . 20n is showing disturbance. In this way, the proposed lidar device 100 is also capable of providing an item of confidence information for a speed value.

FIG. 6 shows a schematic block diagram of a proposed lidar device 100. A transmitting device 10 for repetitively transmitting transmit signals can be recognized. Further, a detector device 20 for detecting radiation reflected by an object can be recognized. Functionally connected to both devices 10, 20 is an evaluation device 30, which ascertains the speed of a detected object in the manner explained above.

The proposed lidar device 100 may be designed, for example, as an ASIC or FPGA of the detector pixels 20a . . . 20n, which enables an evaluation of the extensive measurement data that is close to the hardware and thus efficient. Alternatively, it is also possible to carry out the evaluation of the data on a central computing unit inside or outside the automated vehicle equipped with lidar device 100. As a result, the proposed method can be realized as a computer program product that is executed on associated computer hardware.

Advantageously, the proposed lidar device 100 can be used in partially or highly automated vehicles (SAE levels 1-5).

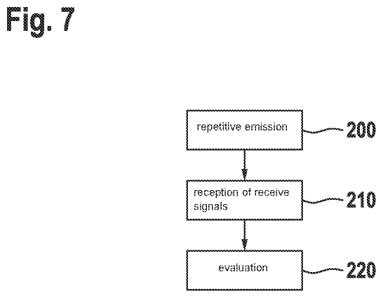

FIG. 7 shows a schematic sequence of a specific embodiment of the proposed method for operating a lidar device 100.

In a step 200, a repetitive emission takes place of transmit signals of a transmitting device 10 with at least one laser element 10a . . . 10n.

In a step 210, a reception takes place of receive signals reflected by an object.

In a step 220, an evaluation takes place of the arrival times of the receive signals acquired per detector pixel 20a . . . 20n in relation to transmission times of the transmit signals, a speed of a detected object being ascertained.

In sum, the present invention proposes a lidar sensor and a method for operating a lidar sensor that provides an acquisition of radial speed in a simple manner.

The person skilled in the art will recognize that a large number of modifications are possible without departing from the core of the present invention.

1-10. (canceled)

11. A lidar device, comprising:
a transmitter device including at least one laser element;
a detector device including a defined number of detector pixels;
wherein the transmitter device is configured to emit pulsed transmit signals, which, reflected by an object, are received by the detector device as receive signals; and
an evaluation device configured to ascertain a speed of a detected object from arrival times of the receive signals acquired per detector pixel in relation to transmission times of the transmit signals.

12. The lidar device as recited in claim 11, wherein a number of the laser elements and a number of the detector pixels is the same or different.

13. The lidar device as recited in claim 11, wherein an evaluation of the arrival times in relation of the transmission times is carried out directly on a detector pixel or on a central computing unit.

14. The lidar device as recited in claim 11, wherein measurements are carried out individually for each of the detector pixels.

15. The lidar device as recited in claim 11, wherein measurements for a plurality of the detector pixels are carried out simultaneously.

16. The lidar device as recited in claim 11, wherein a minimum error square is used for matching between measurement values.

17. The lidar device as recited in claim 16, wherein a further object can be detected from a goodness of fit of a mathematical function between the measurement values.

18. The lidar device as recited in claim 11, wherein each of the detector pixels is one of the following: SPAD diode, avalanche photodiode, CCD sensor.

19. A method for operating a lidar device, comprising the following steps:
repetitively emitting transmit signals of a transmitting device using at least one laser element;
receiving receive signals reflected by an object; and
evaluating of arrival times of the receive signals acquired per detector pixel in relation to transmission times of the transmit signals, and ascertaining a speed of a detected object based on the evaluation.

20. A non-transitory computer-readable data carrier on which is stored a computer program including program code for operating a lidar device, the program code, when executed by a processor, causing the processor to perform the following steps:
repetitively emitting transmit signals of a transmitting device using at least one laser element;
receiving receive signals reflected by an object; and
evaluating of arrival times of the receive signals acquired per detector pixel in relation to transmission times of the transmit signals, and ascertaining a speed of a detected object based on the evaluation.
